(19) United States
(12) Patent Application Publication
(10) Pub. No.: US 2018/0061037 A1
(43) Pub. Date: Mar. 1, 2018

(54) DYNAMIC, PERSISTENT TRACKING OF MULTIPLE FIELD ELEMENTS

(71) Applicant: THE BOEING COMPANY, CHICAGO, IL (US)

(72) Inventor: Richard Bernard Guthrie, Orlando, FL (US)

(21) Appl. No.: 15/246,057

(22) Filed: Aug. 24, 2016

(51) Int. Cl. G06T 7/00; G06K 9/62; H04N 5/232; G01C 3/08

(52) U.S. Cl. CPC G06T 7/004; G06K 9/6267; G06T 2207/30181; G01C 3/08; H04N 5/23293

(57) ABSTRACT

A targeting system includes a personal display system, an attitude determination unit and processing circuitry. The personal display system generates or enables a live view of a physical environment including a field element. The attitude determination unit measures an attitude of the targeting system. The processing circuitry determines a relative LOS from the targeting system to the field element based on the attitude and a geographic location of the targeting system, and a geographic location of the field element. The processing circuitry determines a relative position in the live view from its center of the field of view to the field element therein based on the relative LOS, and causes the personal display system to display a primary view that overlays and thereby augments the live view, with the primary view including an icon at the relative position that thereby overlays the field element in the live view.

### CROSS-REFERENCE TO RELATED APPLICATION(S)

The present application is related to U.S. patent application Ser. No. 15/180,266, entitled: Systems and Methods for Targeting Objects of Interest in Denied GPS Environments, filed Jun. 13, 2016, and U.S. patent application Ser. No. ______, entitled: Compact Laser and Geolocating Targeting System, filed concurrently with the present application, the contents of both of which are incorporated herein by reference.

### NOTICE OF GOVERNMENT RIGHTS

This invention was made with Government support under Contract No. FA8629-12-C-2421 awarded by The Department of Defense. The Government has certain rights in this invention.

### TECHNOLOGICAL FIELD

The present disclosure relates generally to a targeting system and, in particular, to a targeting system with dynamic, persistent tracking of multiple field elements.

### BACKGROUND

Battlefield situations can be complex, with multiple targets and multiple offensive weapons available. Friendly forces or non-combatants may be present in close proximity to targets. Spotters in forward positions can be used to identify targets but it can be difficult to know which targets have already been identified. Further, more than one spotter may be present so that the same target may be identified more than once while other targets may be skipped over.

Therefore it would be desirable to have a system and method that takes into account at least some of the issues discussed above, as well as other possible issues.

### BRIEF SUMMARY

Example implementations of the present disclosure provide a targeting system and method that relies on sensor and calculated angles of incidences to determine and track the geographic location of field elements such as targets, landmarks or friendly forces. As the targeting system is moved, the system may keep track of the field element and provide an indicator associated with a view of the field element. In some examples, the targeting system may be used in a network of interconnected systems including multiple targeting systems that may classify field elements in an environment, and share those designations across the network to increase the efficiency of sharing field element locations and classifications. In the context of a battlefield environment, this may also enable quicker identification of friendly forces in the vicinity of a target or targets.

The present disclosure thus includes, without limitation, the following example implementations. Some example implementations provide a targeting system for use in a physical environment including a field element, the targeting system comprising a personal display system configured to generate or enable a live view of the physical environment, the live view including the field element and having a field of view centered on a line of sight (LOS) of the targeting system; an attitude determination unit configured to measure an attitude of the targeting system comprising an azimuth and elevation that describe the LOS of the targeting system, and in a tilt of the targeting system; and processing circuitry configured to receive the attitude from the attitude determination unit, and programmed to at least: determine a relative LOS from the targeting system to the field element based on the attitude and a geographic location of the targeting system, and a geographic location of the field element; determine a relative position in the live view from the center of the field of view to the field element therein based on the relative LOS; and cause the personal display system to display a primary view that overlays and thereby augments the live view, the primary view including an icon at the relative position that thereby overlays the field element in the live view.

In some example implementations of the targeting system of any preceding or any subsequent example implementation, or any combination thereof, the attitude determination unit is configured to persistently measure the attitude, and the processing circuitry is configured to persistently receive the attitude, and programmed to persistently determine the relative LOS based on the attitude, determine the relative position in the live view based on the relative LOS, and cause the personal display system to display the primary view including the icon at the relative position.

In some example implementations of the targeting system of any preceding or any subsequent example implementation, or any combination thereof, the targeting system further comprises a memory storing a classification of the field element, the classification being of a plurality of classifications associated with a respective plurality of icons, wherein the processing circuitry is further configured to access the memory, and programmed to cause the personal display system to display the primary view including the icon associated with the classification of the field element.

In some example implementations of the targeting system of any preceding or any subsequent example implementation, or any combination thereof, the processing circuitry is programmed to cause the personal display system to display the primary view further including a notification regarding the field element in an instance in which the relative position and the center of the field of view are co-aligned, the notification being selected from a plurality of notifications based on the classification of the field element.

In some example implementations of the targeting system of any preceding or any subsequent example implementation, or any combination thereof, the field element is one of a plurality of field elements in the physical environment, and the memory stores a classification of each of the plurality of field elements, wherein the processing circuitry is programmed to determine the relative LOS from the targeting system to each of the plurality of field elements, and wherein the processing circuitry is further programmed to identify the field element as having a relative position within the field of view based on the relative LOS from the targeting system to the field element.

In some example implementations of the targeting system of any preceding or any subsequent example implementation, or any combination thereof, the processing circuitry is further programmed to identify another field element as having a relative position outside the field of view based on the relative LOS from the targeting system to the other field element, and wherein the processing circuitry is programmed to cause the personal display system to display the primary view that further includes an arrow indicating a turning direction from the LOS of the targeting system to the other field element.

In some example implementations of the targeting system of any preceding or any subsequent example implementation, or any combination thereof, the processing circuitry is further programmed to cause the personal display system to display a secondary view that also overlays and thereby further augments the live view, the secondary view depicting an area of the environment surrounding the targeting system, and including icons that represent the targeting system and field element.

In some example implementations of the targeting system of any preceding or any subsequent example implementation, or any combination thereof, the targeting system further comprises a memory storing a classification that identifies the field element as a target, and information that indicates a munition assigned to the target, and a minimum safe distance associated with the munition, and wherein the processing circuitry is further configured to access the memory, and programmed to cause the personal display system to display the secondary view including an indicator that indicates the minimum safe distance relative to the target.

In some example implementations of the targeting system of any preceding or any subsequent example implementation, or any combination thereof, the secondary view is centered on the icon that represents the targeting system, wherein the processing circuitry is further programmed to determine a distance from the targeting system to the field element based on the geographic location of the targeting system and the geographic location of the field element, and wherein the processing circuitry is programmed to cause the personal display system to display the secondary view centered on the icon that represents the targeting system, and in which the icon that represents the field element is positioned relative to the center of the secondary view based on the distance from the targeting system to the field element, and the relative LOS from the targeting system to the field element.

In some example implementations of the targeting system of any preceding or any subsequent example implementation, or any combination thereof, the targeting system further comprises a rangefinder configured to measure a range from the targeting system to a landmark in the physical environment, and wherein the processing circuitry is further programmed to determine the geographic location of the targeting system based on the attitude of the targeting system, the range from the targeting system to the landmark, and a geographic location of the landmark.

Some example implementations provide a method of using targeting system in a physical environment including a field element, the method comprising generating or enabling a live view of the physical environment, the live view including the field element and having a field of view centered on a line of sight (LOS) of the targeting system; measuring an attitude of the targeting system in an azimuth and elevation that describe the LOS of the targeting system, and in a tilt of the targeting system; determining a relative LOS from the targeting system to the field element based on the attitude and a geographic location of the targeting system, and a geographic location of the field element; determining a relative position in the live view from the center of the field of view to the field element therein based on the relative LOS; and displaying a primary view that overlays and thereby augments the live view, the primary view including an icon at the relative position that thereby overlays the field element in the live view.

In some example implementations of the method of any preceding or any subsequent example implementation, or any combination thereof, the measuring the attitude, determining the relative LOS, determining the relative position and displaying the primary view are performed persistently.

In some example implementations of the method of any preceding or any subsequent example implementation, or any combination thereof, the field element has a classification of a plurality of classifications associated with a respective plurality of icons, and wherein displaying the primary view includes displaying the primary view including an icon associated with the classification of the field element.

In some example implementations of the method of any preceding or any subsequent example implementation, or any combination thereof, displaying the primary view includes displaying the primary view further including a notification regarding the field element in an instance in which the relative position and the center of the field of view are co-aligned, the notification being selected from a plurality of notifications based on the classification of the field element.

In some example implementations of the method of any preceding or any subsequent example implementation, or any combination thereof, the field element is one of a plurality of field elements in the physical environment, and each of the plurality of field elements have a classification, wherein determining the relative LOS includes determining the relative LOS from the targeting system to each of the plurality of field elements, and wherein the method further comprises identifying the field element as having a relative position within the field of view based on the relative LOS from the targeting system to the field element.

In some example implementations of the method of any preceding or any subsequent example implementation, or any combination thereof, the method further comprises identifying another field element as having a relative position outside the field of view based on the relative LOS from the targeting system to the other field element, and wherein displaying the primary view includes displaying the primary view that further includes an arrow indicating a turning direction from the LOS of the targeting system to the other field element.

In some example implementations of the method of any preceding or any subsequent example implementation, or any combination thereof, the method further comprises displaying a secondary view that also overlays and thereby further augments the live view, the secondary view depicting an area of the environment surrounding the targeting system, and including icons that represent the targeting system and field element.

In some example implementations of the method of any preceding or any subsequent example implementation, or any combination thereof, the field element has a classification that identifies the field element as a target, a munition is assigned to the target, and the munition has a minimum safe distance associated therewith, and wherein displaying the secondary view includes displaying the secondary view including an indicator that indicates the minimum safe distance relative to the target.

In some example implementations of the method of any preceding or any subsequent example implementation, or any combination thereof, the secondary view is centered on the icon that represents the targeting system, wherein the method further comprises determining a distance from the targeting system to the field element based on the geographic location of the targeting system and the geographic location of the field element, and wherein displaying the secondary view includes displaying the secondary view centered on the icon that represents the targeting system, and in which the icon that represents the field element is positioned relative to the center of the secondary view based on the distance from the targeting system to the field element, and the relative LOS from the targeting system to the field element.

In some example implementations of the method of any preceding or any subsequent example implementation, or any combination thereof, the method further comprises measuring a range from the targeting system to a landmark in the physical environment; and determining the geographic location of the targeting system based on the attitude of the targeting system, the range from the targeting system to the landmark, and a geographic location of the landmark.

Some example implementations provide a computer-readable storage medium is provided for use in a targeting system. The computer-readable storage medium is non-transitory and has computer-readable program code portions stored therein that are executable by processing circuitry to cause the targeting system to perform at least a portion of the method of any preceding example implementation, or any combination thereof.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as intended, namely to be combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWING(S)

Having thus described example implementations of the disclosure in general terms, reference will now be made to the accompanying drawings, which are not necessarily drawn to scale, and wherein:

FIG. 1 illustrates a targeting system according to various example implementations of the present disclosure;

FIG. 2 illustrates a simplified battlefield environment in a map view providing context for example implementations;

FIGS. 3 and 4 depict screens of a display device of the targeting system of FIG. 1, in the context of a battlefield environment such as that shown in FIG. 2, according to example implementations;

FIG. 5 is a flowchart illustrating various steps in a method according to various example implementations;

FIG. 6 is a flowchart illustrating various steps in a method according to more particular example implementations;

FIG. 7 is a diagram depicting a frame of reference (i.e., a Cartesian coordinate system) in which an azimuth angle (az) and an elevation angle (el) are defined;

FIG. 8 is a diagram depicting an Earth-centered, Earth-fixed (ECEF) frame of reference with defining parameters for the reference system used by GPS and a graphic representing an Earth Model; and

FIG. 9 is a diagram representing a plane formed from the ECEF Z axis and a point representing a location of an object of interest.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless otherwise indicated, reference something as being a first, second or the like should not be construed to imply a particular order. Also, something may be described as being above something else (unless otherwise indicated) may instead be below, and vice versa; and similarly, something described as being to the left of something else may instead be to the right, and vice versa. Like reference numerals refer to like elements throughout.

Example implementations of the present disclosure are generally directed to a targeting system and, in particular, to a targeting system with dynamic, persistent tracking of multiple field elements in an environment of the targeting system. For the purpose of this disclosure, a field element is any object or personnel unit (single or group) that is identifiable and classifiable. Example implementations will be primarily described in the context of a battlefield environment, and in this context, the field element may be a target, landmark, friendly force or the like.

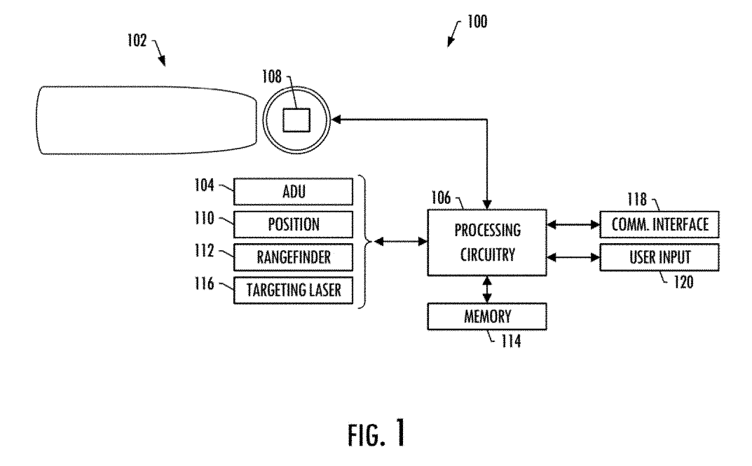

FIG. 1 illustrates a targeting system 100 for use in a physical environment including a field element, according to some example implementations of the present disclosure. According to example implementations, the targeting system includes one or more of each of a number of components. As shown, the targeting system includes a personal display system 102 (both profile and end views schematically shown), an attitude determination unit (ADU) 104 (also known as an attitude reference), and processing circuitry 106. In some example implementations, the personal display system 102 is configured to generate or enable a live view of the physical environment, with the live view including the field element and having a field of view centered on a line of sight (LOS) of the targeting system (the direction the targeting system is pointing).

According to various implementations described herein, the personal display system 102 may include a display device 108 and enable augmented reality functionality in which the live view is augmented with computer-generated input. The personal display system may therefore take, any of a number of different forms suitable for augmented reality. and may be wearable (e.g., head-mounted), handheld or otherwise mobile. In some examples, the personal display system may take the form of augmented reality eyeglasses, telescopes and the like, in which the personal display system may enable a direct live view of the environment. Examples of suitable telescopes include optical telescopes such as spotting scopes, monoculars, binoculars and the like.

In some examples, the personal display system 102 may take the form of or otherwise include an imaging system configured to generate images or video and thereby an indirect live view of the environment. One example of a suitable imaging system is a camera such as a digital camera, infrared camera, thermal camera, depth-aware or range camera, stereo camera or the like, which may be adjustable for parameters such as field-of-view, magnification and the like. In some examples, AR glasses or a telescope may be equipped with an imaging system and thereby generate an indirect live view of the environment, instead of a direct live view. The display device 108 may likewise be any of a number of different display devices suitable to the form of the personal display system. Examples of suitable display devices include image projectors, video projectors, or any of a number of other more conventional display devices such as liquid crystal displays (LCD), light-emitting diode displays (LED), plasma display panels (PDP) and the like.

The ADU 104 is configured to measure an attitude of the targeting system in an azimuth and elevation that describe the LOS of the targeting system 100, and in a tilt of the targeting system. The ADU may include any of a number of different instruments, sensors and the like. For example, the ADU may include a compass such as a digital compass to measure the azimuth of the targeting system with respect to a known direction such as magnetic north. The ADU may likewise include accelerometers or other suitable sensors to measure the elevation and tilt of the targeting system with respect to gravity, with results expressed relative to gravity's orthogonal plane, i.e., level. In other examples, the ADU may employ other attitude determination techniques such as multiple position sensors mounted in a known pattern, or manual entry of azimuth, elevation and tilt.

The processing circuitry 106 may operate alone or in some examples may be a component of a computer system that enables greater functionality. One example of a suitable computer system is described below. In accordance with some example implementations, the processing circuitry is configured to receive the attitude from the ADU 104. The processing circuitry is programmed to determine a relative LOS from the targeting system 100 to the field element based on the attitude and a geographic location (also known as an absolute location) of the targeting system, and a geographic location of the field element. The processing circuitry is programmed to determine a relative position in the live view from the center of the field of view to the field element therein based on the relative LOS. And the processing circuitry is programmed to cause the personal display system 102 to display (using the display device 108) a primary view that overlays and thereby augments the live view, the primary view including an icon at the relative position that thereby overlays the field element in the live view.

In some example implementations of the targeting system 100, the ADU 104 is configured to persistently measure the attitude. In at least some of these examples, the processing circuitry 106 is configured to persistently receive the attitude, and programmed to persistently determine the relative LOS based on the attitude, determine the relative position in the live view based on the relative LOS, and cause the personal display system 102 to display the primary view including the icon at the relative position.

In some example implementations, the targeting system 100 may be configured to determine its own geographic location or otherwise self-locate, and in this regard, the targeting system may further include one or more position sensors 110, a rangefinder 112 or the like, or its geographic location may be manually input. The position sensors can include any of a number of suitable sensors that support various positioning technologies such as satellite-based navigation (e.g., GPS, GLONASS), inertial navigation, Wi-Fi-based positioning, RFID-based positioning, dead-reckoning, association with a known location, triangulation base on landmark locations, and the like. The rangefinder may be of any of a number of suitable types such as a laser rangefinder that uses a laser beam to determine range or distance. Other suitable rangefinder technologies include optical triangulation, radio frequency ranging, photogrammetry with known object identification, and the like.

In addition to or in lieu of position sensors 110, the rangefinder 112 may be co-aligned with the LOS of the targeting system 100 on which the field of view of the live view is centered, and may be used to support self-location of the targeting system. In some example implementations, the rangefinder 112 is configured to measure a range from the targeting system to a landmark in the physical environment. In at least some of these examples, the processing circuitry 106 is further programmed to determine the geographic location of the targeting system based on the attitude of the targeting system, the range from the targeting system to the landmark, and a geographic location of the landmark. More information regarding self-location of the targeting system is provided below and in the above-cited and incorporated '266 application.

In some example implementations, the targeting system 100 further includes a memory 114 storing a classification of the field element, with the classification being of a plurality of classifications associated with a respective plurality of icons. In at least some of these examples, the processing circuitry 106 is further configured to access the memory, and programmed to cause the personal display system 102 to display the primary view including the icon associated with the classification of the field element.

In some further examples, the processing circuitry 106 is programmed to cause the personal display system 102 to display the primary view further including a notification regarding the field element in an instance in which the relative position and the center of the field of view are co-aligned, with the notification being selected from a plurality of notifications based on the classification of the field element.

Additionally or alternatively, in some further examples, the field element is one of a plurality of field elements in the physical environment, and the memory 114 stores a classification of each of the plurality of field elements. In at least some of these examples, the processing circuitry 106 is programmed to determine the relative LOS from the targeting system 100 to each of the plurality of field elements; and further programmed to identify the field element as having a relative position within the field of view based on the relative LOS from the targeting system to the field element.

In some yet further examples, the processing circuitry 106 is further programmed to identify another field element as having a relative position outside the field of view based on the relative LOS from the targeting system 100 to the other field element. In at least some of these examples, the processing circuitry is programmed to cause the personal display system 102 to display the primary view that further includes an arrow indicating a turning direction from the LOS of the targeting system to the other field element.

In some example implementations of the targeting system 100, the processing circuitry 106 is further programmed to cause the personal display system 102 to display a secondary view that also overlays and thereby further augments the live view, with the secondary view depicting an area of the environment surrounding the targeting system, and including icons that represent the targeting system and field element.

In some further examples in which the memory 114 stores a classification that identifies the field element as a target, the memory further stores information that indicates a munition assigned to the target, and a minimum safe distance associated with the munition. In at least some of these examples, the processing circuitry 106 is further configured to access the memory, and programmed to cause the personal display system 102 to display the secondary view including an indicator that indicates the minimum safe distance relative to the target.

Additionally or alternatively, in some further examples, the secondary view is centered on the icon that represents the targeting system, and the processing circuitry 106 is further programmed to determine a distance from the targeting system 100 to the field element based on the geographic location of the targeting system and the geographic location of the field element. In at least some of these examples, the processing circuitry is programmed to cause the personal display system 102 to display the secondary view centered on the icon that represents the targeting system, and in which the icon that represents the field element is positioned relative to the center of the secondary view based on the distance from the targeting system to the field element, and the relative LOS from the targeting system to the field element.

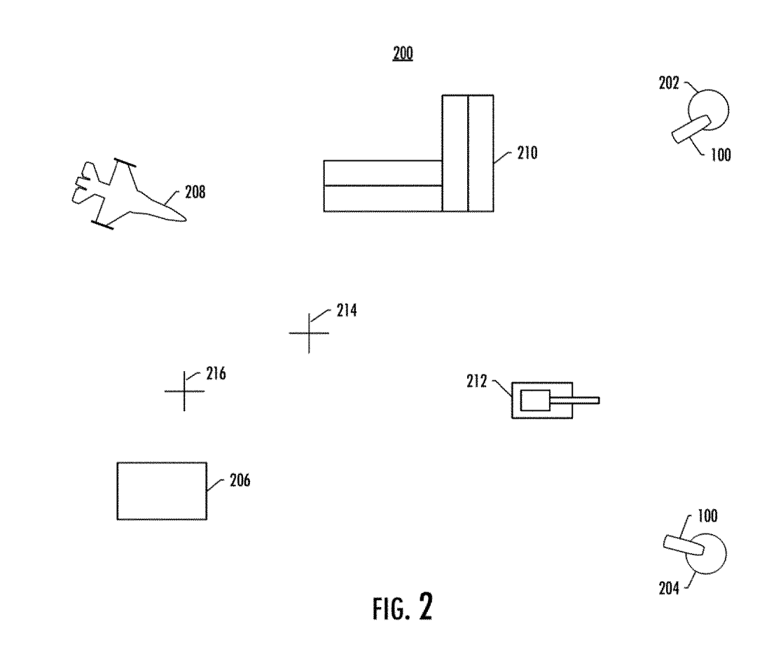

To further illustrate various example implementations in which the targeting system 100 is particularly useful in a battlefield environment, reference is now made to FIGS. 2, 3 and 4. FIG. 2 illustrates a simplified battlefield environment 200 in a map (overhead) view, and in which a network of interconnected tactical units (sometimes referred to as tactical field units) including multiple targeting systems may be useful. As shown, the battlefield environment may include first and second spotters 202, 204 carrying respective targeting systems, and a command hub 206 that in some examples may coordinate information passed between the spotters and with other tactical units such as an aircraft 208. Additionally or alternatively, the spotters may be in direct communication.

The battlefield environment 200 includes a number of field elements, which as indicated above, may include targets, landmarks, friendly forces and the like. As shown, for example, a building 210 may be categorized as a landmark, as may other relatively-fixed features such as antenna towers, bridges, natural features, long-term encampments, etc. FIG. 2 illustrates a target 212 in the form of a tank, as well as first and second friendly forces 214, 216. The friendly forces may range from individual troops or other spotters to platoon or larger sized troop groups, field artillery units, tanks, transports, etc. The aircraft 208 is representative of various observation and offensive capabilities available in a battlefield environment. Other examples include, but are not limited to, mortar, artillery, and rocket units. While a limited number of field elements are illustrated for simplicity, in practice, many more such elements may be present. In various examples, the targeting system 100 may simultaneously display 100 field elements and store relevant information for 1000 field elements.

In accordance with example implementations, the targeting system 100 may be configured for use by an operator such as a spotter 202, 204 in the battlefield environment 200 to mark a target 212 using a coded laser signal (e.g., pulse coded signal) so that a munition or a projectile can be directed to the target, either directly or via a handoff to another tactical unit. In various examples, the munition may be a smart bomb, a guided missile, or some other programmable weapon, which may be delivered via an aircraft 208 or other suitable tactical unit. Returning to FIG. 1, in some example implementations, the targeting system may include a targeting laser 116 or another laser such as a night-vision compatible pointer to emit the coded laser signal to allow association of that particular target with a particular spotter. In some examples, this targeting laser may be co-aligned with the LOS of the targeting system, and perhaps thereby also the rangefinder 112. The ability to coordinate with a tactical unit to identify the particular target to be engaged has practical advantages that will be discussed in more detail below.

In some examples, the personal display system 102 may be used by the operator (e.g., spotter 202, 204) to identify field elements in the field of view of the live view. In addition, in some examples, the personal display system may be used to identify the coded laser signal to enable the targeting system 100 to confirm that a target in the field of view, such as a target at or proximate the center of the field of view (and possibly thereby aligned with the LOS of the targeting system), is actually being illuminated by its own rangefinder 112 or targeting laser 116 and not that of another targeting system. In some examples, the coding scheme for the coded laser signal is controlled by North America Trade Organization (NATO) Standard Agreement (STANAG) 3733, and the targeting system includes a separate component to decode and indicate direction to the laser spot.

The targeting system 100 may also include a communication interface 118 to enable wired or wireless communication between targeting systems, with the command hub 206, and/or other tactical units such as the aircraft 208. The communication interface enables communication with related entities, including any command hub or other tactical units, which may improve friendly forces fighting efficiency by coordinating targets among multiple targeting systems and multiple tactical field units, as well as helping to safeguard friendly troops.

The targeting system 100 may further include a user input interface 120 to enable an operator to input data and make selections of both menu items and elements observed on the display device 108.

In some examples, either or both the communication interface 118 or user input interface 120 enables data input to the targeting system 100, which may store the data input in its memory 114. This capability may allow the targeting system to be pre-programmed for a particular battlefield environment 200 and expected conditions, prior to deployment in a tactical situation, to save time and reduce the need for real time communication of data that is in most cases substantially static.

The data input or other data stored in the memory 114 may include landmark data, tactical information, battlefield element data and the like, which may be used by the targeting system 100 to generate the primary and secondary views that overlay and augment the live view generated or enabled by the personal display system 102. The landmark data may include the geographic locations of landmarks and perhaps other related data, such as identification information associated with landmarks so that particular features such as signage may be identified. The landmark data may be developed from satellite images and legacy map data, or the landmark data may include other geolocation sources, including the targeting system itself.

The landmark data is useful for orienting an operator such as a spotter 202, 204 in a tactical situation, particularly when satellite navigation positioning information, for example, GPS, is not available. In examples in which the ADU 104 includes a compass, the landmark data may also be used for calibration of the magnetic compass. For example, when the geographic location of the targeting system 100 is known, and the geographic location of a landmark is available, the targeting system can calculate the compass heading at which the landmark should appear, and if there is a discrepancy between the calculated and observed headings, an adjustment to the compass can be made. The compass can thus be calibrated for local anomalies or other calibration errors.

Tactical information may include, for example, field elements such as targets and other assets available for offensive operations as well as detailed information about particular munitions, such as a risk estimate distance. As described above, this risk estimate distance is a minimum safe distance associated with the munition, and may therefore be a measure of how far friendly forces 214, 216 should be from a target 212 to avoid unintended damage to equipment or injury to personnel when a particular munition is used. Battlefield element data may include, for example, the last known geographic location of friendly forces, the last location of previously-identified targets, or other tactical information.

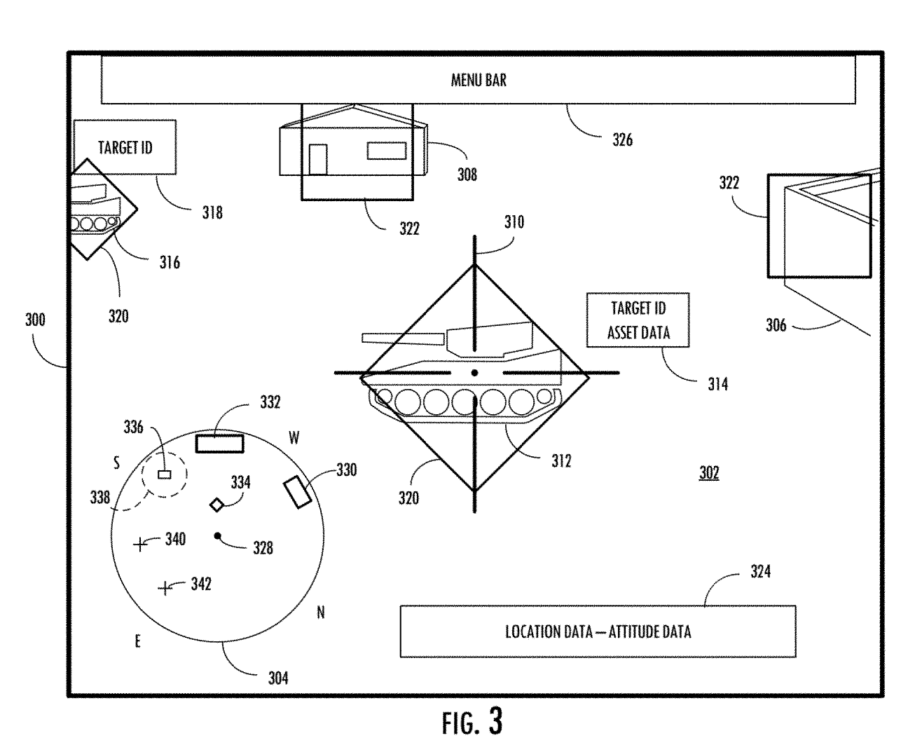

FIG. 3 depicts a screen 300 of the display device 108 of the targeting system 100 in which primary and secondary views 302, 304 may be displayed and overlay a live view of a battlefield environment (e.g., battlefield environment 200). As indicated above, in some examples, the live view is a direct live view of the environment as may be seen through augmented reality eyeglasses, telescope or the like. In other examples, the live view is an indirect live view of the environment that may comprise images or video generated by an imaging system such as a digital camera.

As shown in FIG. 3, the live view of the environment includes first and second landmarks 306, 308 in the form of buildings. In the primary view 302, a reticle 310 overlays a target 312 indicating that the target is currently aligned with the LOS of the targeting system. A target window 314 shows a target identifier indicating the target has been identified and, when available, asset data indicating what tactical unit (aircraft) and munition type are assigned to the target.

A second target 316 may be in the field of view of the live view. When the second target has already been identified, the primary view 302 may include an associated target window 318 to indicate both that the target is known and to indicate the relevant information for the second target. The second target may have been previously identified by the current targeting system 100, such as one used by a first spotter 202, or by another targeting system, such as one used by a second spotter 204 (FIG. 2).

In some examples, the primary view 302 may include a target icon 320 in the form of a diamond that overlays and thereby highlights each of the targets 310, 316. When color is used, the target icon may be red. Similarly, the primary view may include an object icon 322 in the form of a square to overlay and thereby identify the landmarks 306, 308 or other non-threat field elements. In some examples, portions of the target icons and object icons are unfilled so that the respective field elements in the live view are visible through the icons. Other icons may also be associated with other field elements, such as friendly troops, etc. And in some examples, the tilt of the targeting system 100 may be used to place the icons overlaying the field elements, and more particularly in some examples, those field elements not centered in the field of view.

In some examples, the targeting system 100 has a shared optics system that allows the personal display system 102, rangefinder 112 and perhaps also the targeting laser 116 to share the same aperture (external-facing optical lens). In other examples, these components do not share the same aperture, but their lines-of-sight are parallel.

The personal display system presents an LOS-centered view on the display device 108, and the targeting system is aware of its own attitude and geographic location, and the geographic locations of field elements, allowing the targeting system to maintain icons 320, 322 over respective field elements, even though the personal display system itself does no image recognition. Unlike other augmented reality in which computer vision and optical recognition are used to identify something shown on a display and present related information, the targeting system of example implementations may place the icons in the primary view 302 at calculated positions (display coordinates) based on the field of view of the live view and perhaps also a selected zoom level independent of the live view and selected zoom level without regard to the viewability of the field elements. This allows icons to accurately reflect the locations of respective field elements even if they are completely obscured by smoke or hidden by darkness.

As also shown, the primary view 302 may include a status bar 324 that indicates a status of the targeting system 100, such as its geographic location, attitude and the like. Even further, either as part of or separate from the primary view, the screen 300 may include a menu bar 326 to show operational selections and status data such as an optical setting. These selections may include, for example, selections of visible or infrared light, frame capture, target identification options, landmark selections, and sending a transmission with current data.

Moreover, although not separately shown in FIG. 3, the primary view 302 may include an arrow indicating a previously identified field element such as a target that is outside the primary view, and a turning direction from the LOS of the targeting system 100 to the respective field element. This arrow may thereby indicate the direction the targeting system must be turned to place the field element back in the primary view.

The secondary view 304 is shown in FIG. 3 with the current targeting system 100 being shown by an icon at a center 328. The secondary view, also known as a radar view or polar view, illustrates all identified field elements in the vicinity of the targeting system whether or not in the current field of view of the live view generated or enabled by the personal display system 102. That is, the secondary view may be used to show identified elements that may be behind the spotter 202, 204 (FIG. 2), or as a quick indication of which way to turn to most easily bring a particular field element into view.

In this example implementation, the current LOS (heading) is shown at the top of the secondary view. In a different example implementation, the secondary view is fixed in a predetermined direction, such as north. In an example implementation, this choice of view may be selectable to accommodate a particular operator or for ease of communication with a related asset, such as the second spotter. As illustrated in FIG. 3, the field elements in the current field of view of the live view include the landmarks 306, 308 as shown by icons 330, 332, respectively and the target 312 is shown by icon 334.

The second target 316 is indicated by icon 336, which is surrounded with a risk estimate distance indicator 338 illustrating a risk estimate distance for the munition assigned to the target. As suggested above, the risk estimate distance is the distance beyond which friendly forces should be from the second target to avoid unintended damage to equipment or injury to personnel. The risk estimate distance indicator is shown for the second target but in various example implementations may be shown for any and all targets to which a munition or munition type has been assigned, thus allowing a risk estimate distance to be assigned. This assignment is made locally using stored data for various munitions or munition types in one example implementation, while in another example implementation the information is sent to the targeting system 100 from the command hub 206 or other data source (not shown).

Also shown in the secondary view 304 are first and second friendly force 340, 342, which may be pre-programmed in the targeting system 100, identified by the targeting system or another targeting system, or sent from the command hub 206 based on other geographic location information. The ability to locate friendly forces gives several advantages, from being aware of the risk estimate distance with respect to a friendly force, to being notified when a friendly force is in the reticle or even targeted in error.

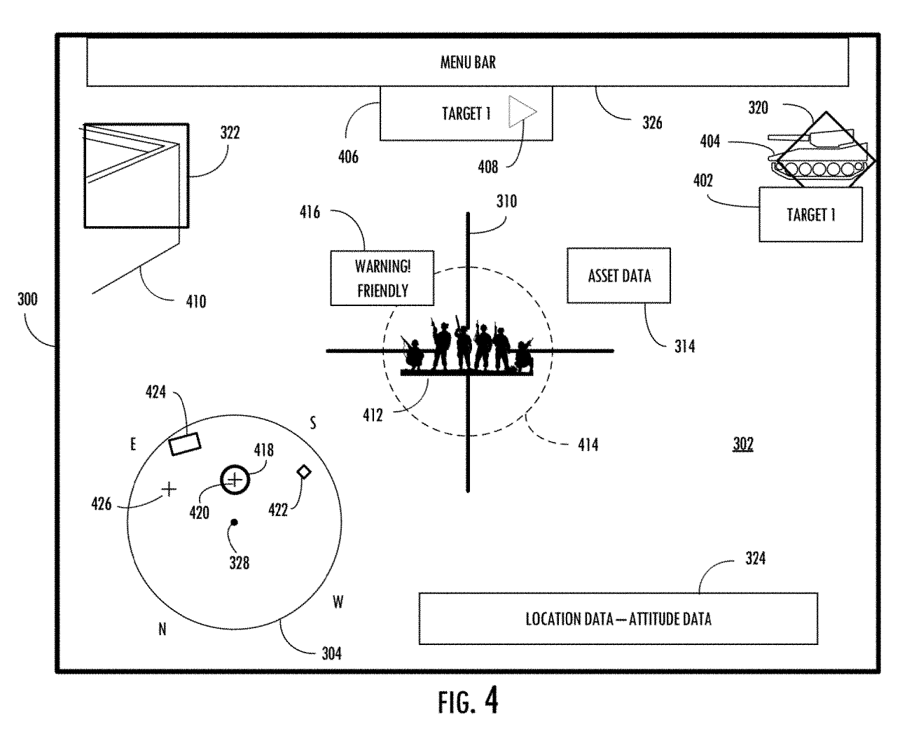

FIG. 4 is another depiction of the screen 300 of the display device 108 of the targeting system 100. As illustrated in FIG. 4, the primary view 302 shows a target information window 402 for a target 404 in the field of view, identifying the target as “Target 1.” A drop-down box 406 can be used to select a previously identified field object, in this case Target 1, and it or another box may include an arrow 408 that indicates a direction (turning direction) in which the targeting system 100 must turn to center the selected field object (Target 1) in the field of view of the live view (centered on the LOS of the targeting system).

Also shown in FIG. 4 are a landmark 410 and a group of personnel 412 in the reticle 310 aligned with the LOS of the targeting system 100 on which the field of view of the live view is centered. Also shown in the primary view 302 are notifications in the form of a warning indicator 414 and a pop-up box 416 that both separately indicate that the group has been previously classified as a friendly force. Obviously, targeting friendly forces is undesirable so the warning indicator and pop-up box serve to increase the safety of friendly forces and reduce the risk of unintended damage to equipment or injury to personnel. A similar warning icon 418 is shown in the secondary view 304 around the icon 420 for the friendly force. Also shown in the illustrated example implementation are icons 422, 424 representing respectively the target 404 and landmark 410, as well as another friendly force icon 426.

Referring in particular to FIGS. 1, 2 and 3, according to some example implementations in which the targeting system 100 is used by the first spotter 202 in the battlefield environment, the ADU 104 of the targeting system provides azimuth and elevation that describe the LOS of the targeting system. The rangefinder 112 or targeting laser 116 of the targeting system may use a coded signal to indicate a target 312 to another observer, in some example implementations, an aircraft 208 or another spotter 204, or that provides the range from the targeting system to the respective target. In an example implementation, the coded signal and either or both the relative location or absolute location of the target may be supplied to the other observer. Knowledge of the targeting system's geographic location, azimuth, elevation (angle up or down from horizontal), and range to the target allows accurate computation of the geographic location (absolute location) of the target. Either or both the target's geographic location or the coded signal can be used to direct an appropriate munition to the target. The target's geographic location may be saved in memory 114 and referred to as other targets 316 are spotted, and as the geographic location, azimuth and/or elevation of the targeting system changes.

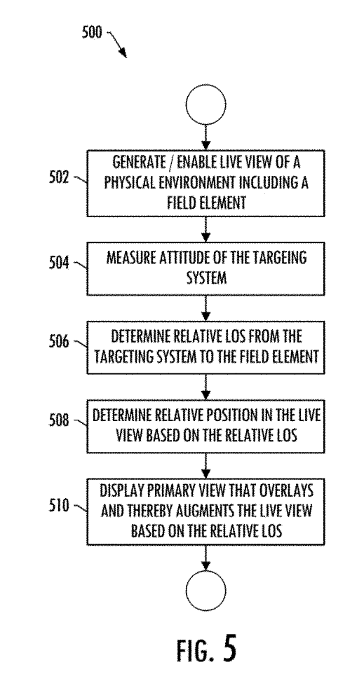

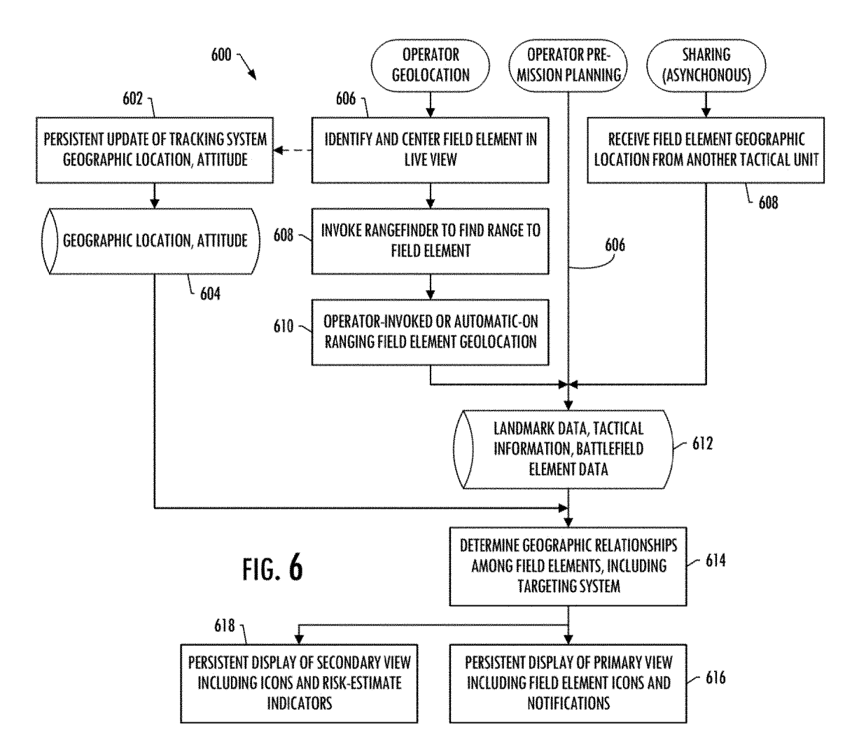

Having described the targeting system 100, its various components and how it may be configured for particular use in a battlefield environment 200, FIGS. 5 and 6 illustrate various operations in methods of using a targeting system generally in a physical environment and more particularly in a battlefield environment, according to example implementations of the present disclosure.

FIG. 5 illustrates a method 500 of using a targeting system in a physical environment including a field element, according to example implementations of the present disclosure. As shown at block 502, the method includes generating or enabling a live view of the physical environment, with the live view including the field element and having a field of view centered on the LOS of the targeting system. As shown at block 504, the method includes measuring an attitude of the targeting system in an azimuth and elevation that describe the LOS of the targeting system, and in a tilt of the targeting system. The method includes determining a relative LOS from the targeting system to the field element based on the attitude and a geographic location of the targeting system, and a geographic location of the field element, as shown at block 506. The method includes determining a relative position in the live view from the center of the field of view to the field element therein based on the relative LOS, as shown at block 508. And the method includes displaying a primary view that overlays and thereby augments the live view, with the primary view including an icon at the relative position that thereby overlays the field element in the live view, as shown at block 510.

FIG. 6 illustrates a method 600 of using a targeting system 100 in a battlefield environment 200 including a field element, according to example implementations of the present disclosure. As shown at block 602, the method includes determining and persistently updating the targeting system's attitude and geographic location (self-location). In various examples, the attitude includes both a compass direction (azimuth), an angle from horizontal in the plane of gravity and the line-of-sight (elevation), and another angle from horizontal in the plane of gravity and the direction orthogonal to the plane of gravity and the LOS (tilt). In one example, the attitude is sensed via the ADU 104, which may include a digital compass.

In one example, the targeting system 100 may self-determine its geographic location using its position sensor(s) 110 and/or rangefinder 112. In some examples, either or both the attitude or geographic location may be independently updated at a fast rate or rates, with storage for asynchronous access (block 604). This may facilitate asynchronous targeting processes for geolocation and display always or nearly always having very recent and correct attitude and targeting system geographic location available, and the rate may be fast enough such that the display appears continuous to the operator.

As also shown, the method 600 includes various operations according to which the targeting system 100 may obtain the geographic locations of field elements in the battlefield environment. As shown at 606, the targeting system may be pre-programmed with landmark data for a particular battlefield environment 200; or as shown at block 608, the targeting system may receive landmark data from another tactical unit such as another targeting system 100, command hub 206, aircraft 208 or the like. In these examples, the targeting system may be pre-programmed or receive the landmark data via various means such as its communication interface 118 or user input interface 120.

In another example according to which the targeting system 100 may obtain the geographic locations of field elements, an operator may identify a field element using the personal display system 102 and center the field element in the field of view of the live view, as shown at block 606. This may correspond to the reticle 310 overlaying the target 312 and thereby indicating that the target is currently aligned with the LOS of the targeting system (FIG. 3). At this time, the operator may mark the field element (and in particular a target) using a coded laser signal (not separately shown in FIG. 6). The operator may also invoke the rangefinder 112 (e.g., using menu bar 326) to determine the range from the targeting system to the field element, as shown at block 608. The targeting system may then use the most recent attitude and geographic location of the targeting system, and the range to the field element to determine (geolocate) the geographic location of the field element, as shown at block 610. In various examples, geolocation of the field element may be operator invoked or invoked automatically upon determination of the range to the field element.

Regardless of the particular manner according to which it is obtained, the targeting system 100 may send the geographic location of the field element to other tactical units (e.g., another targeting system 100, command hub 206, aircraft 208). The targeting system may also add the geographic location of the field element to the landmark data, tactical information, battlefield element data and the like stored in memory 114 of the targeting system, as shown at block 612. This data may be accumulated from the targeting system and other tactical units in any of a number of suitable manners, and may include data for known field elements one or more of which may be classified by the operator. Examples of suitable classifications include target, friendly, landmark or simply “undeclared” if the nature of the field element is not assigned by the operator.

As shown at block 614, the method includes determining relationships among field elements in the battlefield environment 200, and including the targeting system 100. These relationships may include geometric relationships determined based on the attitude and geographic location of the targeting system, and geographic locations of the field elements. In FIG. 3, this may include relationships among landmarks 306, 308, targets 312, 316, any friendly forces and any unclassified field elements, and the targeting system.

Determining the geometric relationships may also include the targeting system 100 determining a relative LOS and distance from the targeting system to each field element in the field of view. This relative LOS may be used to determine the relative position from the center of the field of view to the field element in the live view for placement of the appropriate icon that overlays the field element in the primary view, and any notifications (e.g., warnings) regarding the field element in the primary view, as shown in block 616. The relative LOS and distance may be used for placement of appropriate icons representing the field elements in the secondary view, as shown in block 618. And as explained above, the secondary view may also include any appropriate risk estimate distance indicators for targets that indicates the minimum safe distance associated with a munition assigned to the target.

The targeting system 100 of various example implementations is location and/or attitude aware. Even if the targeting system is moved to a new location, rotated, or elevated, the geographic location of the field element is still known, so that the targeting system will continue to know the location of the field element with respect to the new location and attitude of the targeting system.

As described above, the targeting system 100 and methods according to example implementations of the present disclosure may use geographic location (absolute location) to determine geographical (spatial) relationships between one or more targeting systems and a variety of field elements. In some examples, the development of these geographical relationships uses an earth-centered approach to reckoning the relationships among the targeting system itself and hundreds or more of field elements. The following describes an example implementation for providing geographic location of objects that is suitable for use in example implementations of the targeting system and methods described above.

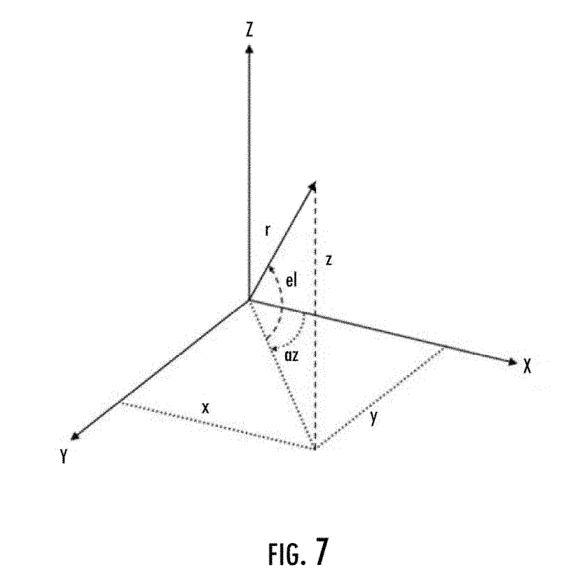

FIG. 7 is a diagram depicting a frame of reference (i.e., a Cartesian coordinate system) in which an azimuth angle (labeled “az”) and an elevation angle (labeled “el”) are defined. FIG. 7 also shows the relationship of azimuth and elevation to the X, Y and Z axes. Azimuth is defined as positive in the direction from +X towards +Y. Elevation is defined as positive in the direction from the X-Y plane towards +Z. The relationships between the various angles and distances for a field element located at a distance r from the origin of the Cartesian coordinate system with an azimuth angle “az” and an elevation angle “el” are (written in computer language in which “atan2” means “full-circle arctangent”) as follows:

az=atan2(y, x)

el =atan2(z, (x²+y²)^{1/2})

r=(x²+y²+z²)^{1/2}

r cos(el)=(x²+y²)^{1/2}

x=r cos(el)cos(az)

y=r cos(el)sin(az)

z=r sin(el)

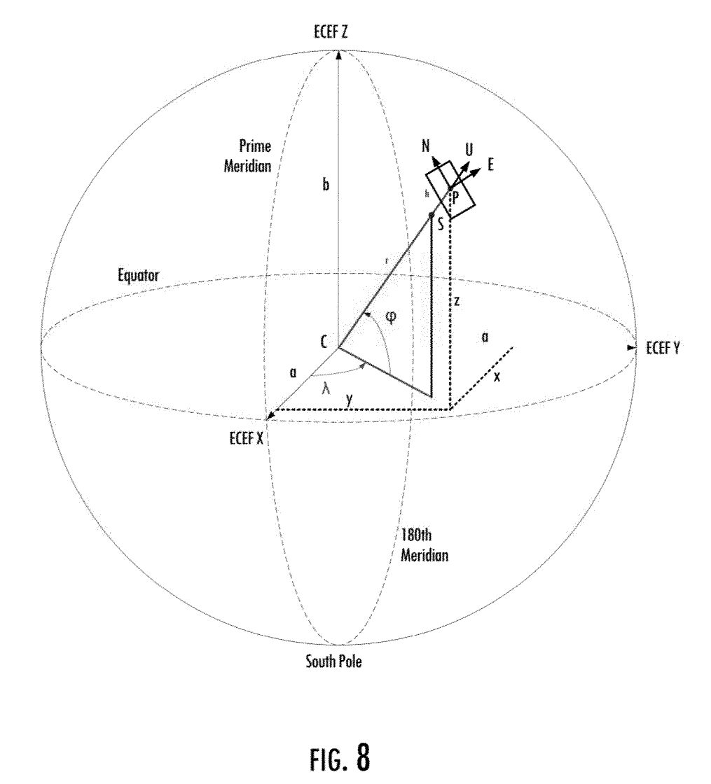

The Earth-centered, Earth-fixed (ECEF) frame of reference is referred to extensively in the following detailed description. The origin of the ECEF frame of reference is the center of the Earth, with X passing through the intersection of the Equatorial and Prime Meridian Great Circles, and Z pointing through the North Pole. The ECEF frame of reference is right-handed. FIG. 8 is a diagram depicting the ECEF frame of reference with defining parameters for the reference system used by the GPS and a graphic representing the Earth Model. Latitude and longitude are the names of elevation and azimuth, respectively, in the ECEF frame of reference.

More specifically, FIG. 8 provides a graphic and defining parameters for the World Geodetic System (hereinafter “WGS84”), which is the frame of reference currently used by the GPS. The WGS84 frame of reference defines an ellipse with its minor axis in ECEF Z and its major axis in the plane of ECEF Y and ECEF X. The ellipse is rotated about ECEF Z to form a surface of revolution. The surface of revolution is the Earth

Model. The height h of point P in FIG. 8 is defined as its distance from the Earth Model along a ray extending from the ECEF origin through point P. Since the Earth Model is defined by an ellipse with unequal axis lengths, height h is latitude dependent. The local geodetic frame of reference, including North (N), East (E) and Up (U), is also shown in FIG. 8.

The WGS84 standard defines a reference ellipsoid for Earth as follows:

ellipsoid semi-major axis length a=6378137.0 m

ellipsoid flattening f is defined by 1/f=298.257223563

ellipsoid semi-minor axis length b=a(1−f)

Other terms which appear in FIG. 8 are defined as follows:

P—point of interest

C—ECEF origin (center of Earth)

ECEF X, Y, Z—ECEF directions

x, y, z—ECEF coordinates of P

S—point on ellipsoid directly “below” P

h—height of P above S (also called altitude)

λ—longitude (generically, azimuth)

φ—latitude (generically, elevation)

r—distance from C to S (since a≠b, r is latitude dependent)

E, N, U—the local geodetic directions East, North, Up from P

The coordinates P(x,y,z) of point P may be found from φ, λ and h by first finding r according to the following equation:

r=a/(1(1−b²/a²)sin² φ)^{1/2}

Then

x=(h+r)cos(φ) cos(λ)

y=(h+r)cos(φ)sin(λ)

z=(h+rb²/a²)sin(φ)

The relationship between the local geodetic coordinate system (ENU) and an ECEF-parallel coordinate system with the same origin is given by the following transformation matrix from local geodetic (G) to ECEF-parallel (E):

$$CGE = [ \begin{matrix}- sin ( λ ) & cos ( λ ) & 0 \\ - cos ( λ ) sin ( ϕ ) & - sin ( λ ) sin ( ϕ ) & cos ( ϕ ) \\ cos ( λ ) cos ( ϕ ) & sin ( λ ) cos ( ϕ ) & sin ( ϕ )\end{matrix} ]$$

An additional frame of reference requiring definition is the LOS frame of reference. In one example, LOS X corresponds to the center of the field of view of the live view generated/enabled by the personal display system 102, centered on the LOS of the targeting system 100, with which the rangefinder 112 may be co-aligned. LOS Z is “up” as seen on the personal display system. LOS Y is “right” as seen on the personal display system.

In addition, the ADU 104 has a frame of reference referred to herein as “Body,” which may be misaligned with the LOS frame of reference. Mounting compensations in roll, pitch, and yaw are used to correct for these differences.

Finally, the term “magnetic declination” is used herein. If a compass is used for determining heading to a point or object, the difference between the direction to the Magnetic Pole and true North is important. Magnetic declination is the angle between true North and magnetic North, and is positive when magnetic North is east of true North. This can be expressed by the following equation: True Bearing=Magnetic Bearing+Magnetic Declination.

### Geolocation

To establish the geographic location of a remote object such as a field element, the operator of the targeting system 100 directs personal display system toward the field element and centers the field element in the live view. The operator then uses a co-aligned rangefinder 112 to find the field element's range, i.e., the distance from the targeting system to the field element. The processing circuitry 106 of the targeting system is configured to use the system's attitude and geographic location, and the range from the system to the field element, to determine the field element's geographic location.

The geolocation inputs to the processing circuitry 106 may include the following information:

Range—range to field element (measured by the rangefinder 112)

R_{C}—roll compensation to ADU frame of reference (a measured value)

P_{C}—pitch compensation to ADU frame of reference (a measured value)

Y_{C}—yaw compensation to ADU frame of reference (a measured value)

R_{A}—roll attitude (measured by the ADU 104—e.g., digital compass)

P_{A}—pitch attitude (measured by the ADU—e.g., digital compass)

Y_{A}—yaw attitude (heading relative to magnetic North measured by the ADU—e.g., digital compass)

Y_{D}—magnetic declination

LAT—geodetic latitude (WGS84) of the targeting system 100 (determined using GPS signals or landmark-based self-location)

LON—geodetic longitude (WGS84) of the targeting system (determined using GPS signals or landmark-based self-location)

H—geodetic height (WGS84) of the targeting system (determined using GPS signals or landmark-based self-location).

Notationally, a 3×3 single-axis transformation matrix is denoted as <angle>, where <angle> will be one of the angles given above. There are three forms used for the single-axis 3×3 matrix. The particular form is determined by the axis that the transformation matrix is transforming about. The three forms for pitch, yaw and roll are as follows:

$$Pitch \text{:} [ \begin{matrix}cos < angle > & 0 & - sin < angle > \\ 0 & 1 & 0 \\ sin < angle > & 0 & cos < angle >\end{matrix} ]$$

$$Yaw \text{:} [ \begin{matrix}cos < angle > & sin < angle > & 0 \\ - sin < angle > & cos < angle > & 0 \\ 0 & 0 & 1\end{matrix} ]$$

$$Roll \text{:} [ \begin{matrix}1 & 0 & 0 \\ 0 & cos < angle > & sin < angle > \\ 0 & - sin < angle > & cos < angle >\end{matrix} ]$$

It is usually obvious by the name of the angle which form is used.

When one or more single-axis 3×3 transformation matrices have been multiplied, the resulting matrix is conventionally called a direction cosine matrix and denoted by Cxy, where x and y denote respective frames of reference (L—line B—body; G—geodetic; E—ECEF-paralle1). The name may be interpreted as the matrix that transforms from the x frame of reference to the y frame of reference. For example, CLB is a direction cosine matrix that transforms from the line-of-sight frame of reference to the body frame of reference, and CBG is a direction cosine matrix that transforms from the body frame of reference to the geodetic frame of reference.

In some examples, the geolocation algorithm includes operations performed. by the processing circuitry 106 of the targeting system 100 based on one or more computer programs stored in memory 114, as explained in greater detail below. These computer program(s) (written in computer language) include the generation of the following transformation matrices:

$$// LOS to Body ( correct for sensor \text{-} to \text{-} compass misalignment )$$

$$CLB = [ {Y}_{C} ] [ {P}_{C} ] [ {R}_{C} ] \\ // Body to Geodetic$$

$$CBG = [ {Y}_{A} + {Y}_{D} ] [ {P}_{A} ] [ {R}_{A} ] \\ // Geodetic to ECEF \text{-} parallel \\ // [ LAT ] uses the pitch matrix form , [ LON ] uses the roll$$

$$matrix form$$

$$CGE = [ \begin{matrix}0 & 0 & 1 \\ 0 & - 1 & 0 \\ 1 & 0 & 0\end{matrix} ] [ - LON ] [ - LAT ] \\ // ECEF \text{-} parallel to Geodetic$$

$$CEG = transpose ( CGE ) \\ // LOS to ECEF \text{-} parallel$$

$$CLE = CGE CBG CLB \\ // ECEF \text{-} parallel to LOS$$

$$CEL = transpose ( CLE )$$

After the transformation matrices have been generated, the processing circuitry 106 calculates the ECEF position (the geographic location) of the targeting system 106 using a=6378137.0 and f=1/298.257223563. (In computer language, the “=” sign does not mean “equal to” but rather means “is assigned” (e.g., retrieve from memory 114) that value and set the parameter to the retrieved value.) In particular, the processing circuitry calculates b=a(1−f), and N=a/(1−(1−b²/a³)sin²(lat))^{1/2}. Then the processing circuitry calculates the system's ECEF coordinates as follows:

ECEFx=(h+N)cos(lat)cos(lon)

ECEFy=(h+N)cos(lat)sin(lon)

ECEFz=(h+Nb²/a²)sin(lat)

After the ECEF position (geographic location) of the targeting system 100 has been calculated, the processing circuitry 106 then calculates the position (geographic location) of a field element in ECEF coordinates as follows:

$$[ \begin{matrix}ECEFxo \\ ECEFyo \\ ECEFzo\end{matrix} ] = CLE [ \begin{matrix}Range \\ 0 \\ 0\end{matrix} ] + [ \begin{matrix}ECEFx \\ ECEFy \\ ECEFz\end{matrix} ]$$

After the position of the field element in the ECEF frame of reference has been calculated, the processing circuitry 106 converts that ECEF position into the corresponding lat, lon, h coordinates of the position of the field element in the WGS84 frame of reference using the following algorithm.

To determine the longitude of the field element,consider that y/x may be expressed (using the equations given above) as:

y/x=((h+N)cos(lat)sin(lon))/((h+N)cos(lat)cos(lon)),

From this, the processing circuitry 106 may obtain y/x=sin(lon)/cos(lon) and y/x=tan(lon), or lon=atan2(y,x) (“atan2” is used because a full circle arctangent is needed). Finding latitude and height is independent of longitude, and so can be worked in the plane of the Meridian containing the field element.

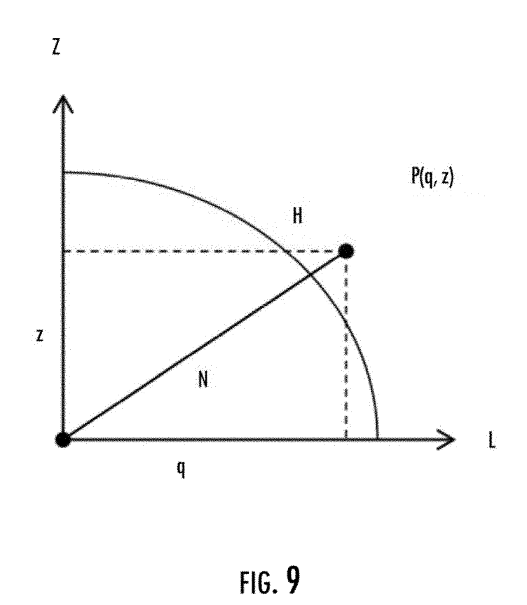

FIG. 9 is a diagram representing a plane formed from the ECEF Z axis and a point representing a location of a field element. The cross-Z component is shown in FIG. 9 as “q,” the root of the sum of the squares of x and y, i.e., q=(x²+y²)^{1/2}. Since q²=(x²+y), one may substitute for x and y to give:

q²=((h+N)cos(lat)cos(lon))²+((h+N)cos(lat)sin(lon))²

or

q²=(h+N)²cos²(lat)cos²(lon)+(h+N)²cos²(lat)sin²(lon)

Factoring gives the following equation:

q²=(h+N)²cos²(lat)(cos²(lon)+sin²(lon))

Next, apply the trigonometric identity cos²(θ)sin²(θ)=1 to obtain the following equation:

q²=(h+N)²cos²(lat),

which leads to:

q=(h+N)cos(lat)

or

h=q/cos(lat)−N.

Working with the expression for ECEF z:

z=(h+Nb²/a²)sin(lat)

h=z/sin(lat)−Nb²/a²

Equating these expressions for h (that is, h=q/cos(lat)−N=z/sin(lat)−Nb²/a²) and solving for z gives the following sequence:

z/sin(lat)−Nb²/a²=q/cos(lat)−N

z/sin(lat)=q/cos(lat)−N+Nb²/a²

z/sin(lat)=q/cos(lat)−N(1−b²/a²)

z/sin(lat)=q/cos(lat)−e²N

z=sin(lat)(q/cos(lat)−e²N)

This last expression for z is not algebraically solvable for lat, but it does provide a basis for an iterative function to determine a latitude estimate giving a z sufficiently close to the supplied ECEF z. As q is a function of ECEF x and ECEF y, and N is a function of the latitude estimate, for a given scenario, q may be found once but N may be recalculated with each new latitude estimate.

For an estimate of the latitude of the field element called latest, the error function is then:

z_error=sin(lat_est)(q/cos(lat_est)−e²(a/(1−e² sin²(lat_est))^{1/2}))−z

One of several conventional root-finding algorithms may be employed to find a lat_est producing a z_error of sufficiently small magnitude. One suitable root-finding algorithm is the Secant Method, which is fast and does not rely on initial bracketing of the root.

With lat for the field element determined, the equation h=r/cos(lat)−N can be employed to determine h for the field element.

Field Elements In-View 101131 1n some examples, the combined landmark data and battlefield element data represent a list of known objects (field elements), including for each field element, at least a geographic location in ECEF coordinates (ECEFxo, ECEFyo, ECEFzo) and classification. For each of the known objects in the field of view of the live view generated or enabled by the personal display system 102, the processing circuitry 106 may determine a relative position in the live view, and cause the personal display system display a primary view (e.g., primary view 302) with an appropriate icon at that relative position that overlays the field element in the live view. Similarly, the processing circuitry may determine a position for an icon that represents the known objects surrounding the targeting system 100 in the secondary view (e.g., secondary view 304). These positions may be determined and reflected in any of a number of different manners. One suitable manner is described below in which the positions are reflected in display coordinates.

To assign display coordinates in the secondary view and possibly the primary view, the processing circuitry 106 may determine a relative LOS (in azimuth and elevation) and distance from the targeting system 100 to each known object. With this information, and an arbitrary assignment of pixel scaling, the processing circuitry may assign display coordinates for each known object in the secondary view. Also with this information, and an understanding of the field of view of the selected live view, each known object's relative LOS can be evaluated as a candidate for drawing in the primary view, and those objects within the :limits of the primary view may be assigned display coordinates in it. In some examples, the processes of assigning display coordinates in the primary and secondary views, and the drawing of representative graphical symbols (icons) on those views, are performed at a sufficiently high frequency to appear to the operator as being smooth tracking of the icons while the targeting system 100 is being turned or moved.

The calculation of the relative line of sight of each object for the primary view 186, expressed as angle and in pixels relative to the display center, may begin by finding the ECEF-parallel coordinates of the object ‘n’ relative to the targeting system coordinates “T”:

$$[ \begin{matrix}ECEF xp \\ ECEF yp \\ ECEF zp\end{matrix} ] = [ \begin{matrix}ECEFxn \\ ECEFyn \\ ECEFzn\end{matrix} ] - [ \begin{matrix}ECEFx T \\ ECEFy T \\ ECEFz T\end{matrix} ]$$

The LOS coordinates of the object, here called an object of interest (OOI), may then be found using the CEL direction cosine matrix discussed above.

$$[ \begin{matrix}OOIxL \\ OOIyL \\ OOIzL\end{matrix} ] = CEL [ \begin{matrix}ECEF xp \\ ECEF yp \\ ECEF zp\end{matrix} ]$$

Next, the LOS azimuth and elevation to OOI ‘n’ may be found as respectively OOIazn and OOIeln and scaled to pixels from the center of the field of view of the live view, as follows:

OOIazn=atan2(OOIyL, OOIxL)

OOleln=atan2(OOIzL,(OOIxL*OOIxL+OOIyL*OOIyL)^{1/2})

OOIazn_pixels=OOIazn*one_over_primary_view_pixel_size[zoom]

OOIeln_pixels=OOIeln*one_over_primary_view_pixel_size[zoom]

Function atan2 is a full-circle arctangent function. Function one_over_primary_view_pixel_size[] provides a lookup of pixel scaling for the chosen magnification level (here called ‘zoom’) of the primary view. This function may be implemented in any of a number of different manners with the understanding that an image (or display) pixel subtends an arc in screen-horizontal and an arc in screen vertical, with the assumption these are the same (i.e., square pixels), and that the function converts real angle components to numbers of pixels at the chosen magnification level.

For the distance from the targeting system 100 to a known object, the processing circuitry 106 may employ an algorithm to determine the point-to-point distance between any two objects. One example of a suitable algorithm includes, for points n and in, finding relative coordinates of targeting system T to object ‘n’:

$$[ \begin{matrix}ECEF xp \\ ECEF yp \\ ECEF zp\end{matrix} ] = [ \begin{matrix}ECEFxT \\ ECEFyT \\ ECEFzT\end{matrix} ] - [ \begin{matrix}ECEF xn \\ ECEF yn \\ ECEF zn\end{matrix} ]$$

The distance Dn from the targeting system T to object ‘n’ may then be determined as follows:

Dn=(ECEFxp*ECEFxp+ECEFyp*ECEFyp+ECEFzp*ECEFzp)^{1/2}

In some examples, the secondary view (e.g., secondary view 304) may be drawn as a polar view relative to the LOS of the targeting system 100, which may be drawn as display-vertical. In these examples, display coordinates relative to the center of the secondary view (e.g., center 328) may be determined for each object as follows.

For object ‘n’, angles OOIazn and OOIeln, and distance Dn, may be used as calculated above. The value one_over_secondary_view_pixel_size is an implementation-dependent assignment of pixels per unit of distance. This assignment may be implemented in any of a number of different manners with the understanding that in the radar view, range in meters may be converted to a number of display pixels, and that the angles may be used to determine pixel x and pixel y components for plotting. The display horizontal dimension is labeled X, and the display vertical dimension is labeled Y.

SecondaryViewPixelsXN=Dn*one_over_secondary_view_pixel_size* sin(OOIazn)

SecondaryViewPixelsYN=Dn*one_over_secondary_view_pixel_size* cos(OOIazn)

According to example implementations of the present disclosure, the targeting system 100 and its subsystems and other components may he generally implemented by various means. Means for implementing the system and its subsystems may include hardware, alone or under direction of one or more computer programs from a computer-readable storage medium. As described above, in some examples, the targeting system includes processing circuitry 106 (e.g., processor unit) connected to a memory 114 storage device).

The processing circuitry 106 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 114 (of the same or another targeting system 100).

The processing circuitry 106 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 114 is generally any piece of computer hardware that is capable of storing information such as, for example, data, computer programs (e,g., computer-readable program code) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk read only' memory (CD-ROM), compact disk—read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium,

In addition to the memory 114, the processing circuitry 106 may also be connected to one or more interfaces for displaying, transmitting and/or receiving information. The interfaces may include a communications interface 118 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interlaces may include the display device 108 and/or one or more user input interfaces 120 (e.g., input/output unit). The display may be configured to present or otherwise display information to a user, suitable examples of which are more fully described above. The user input interfaces may be wired or wireless, and may be configured to receive information from an operator into the targeting system 100, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As suggested above, program code instructions may be stored in memory, and executed by processing circuitry that is thereby programmed, to implement functions of the targeting system 100 and its subsystems and other components described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing circuitry or other programmable apparatus to function in a particular manner to thereby generate a particular machine or particular article of manufacture. The instructions stored. in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus,

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing circuitry, or storage of instructions in a computer-readable storage medium, supports combinations of operations for performing the specified functions. In this manner, the targeting system 100 may be a particular configuration of an apparatus including processing circuitry and a computer-readable storage medium or memory coupled to the processing circuitry, where the processing circuitry is configured to execute computer-readable program code stored in the -memory. It will also be understood that one or more functions, and combinations of functions, may be implemented by special purpose hardware-based computer systems and/or processing circuitry which perform the specified functions, or combinations of special purpose hardware and program code instructions.

As described herein, again, example implementations of the present disclosure are generally directed to a targeting system and, in particular, to a targeting system with dynamic, persistent tracking of multiple field elements in an environment of the targeting system. The ability to dynamically indicate and retain target location information for multiple targets, as well as upload and download information about location, landmarks, and friendly forces, among other potential battlefield elements, adds a capability to the targeting system that both enhances tactical strategies and also helps safeguard friendly forces from friendly fire. The additional sensors, combined with enhanced display capabilities, provide the disclosed system with capabilities not found in current targeting devices to the benefit of both the operator of the targeting system, other assets using the target information, and friendly forces in the battlefield environment.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A targeting system for use in a physical environment including a field element, the targeting system comprising:
a personal display system configured to generate or enable a live view of the physical environment, the live view including the field element and having a field of view centered on a line of sight (LOS) of the targeting system;
an attitude determination unit configured to measure an attitude of the targeting system in an azimuth and elevation that describe the LOS of the targeting system, and in a tilt of the targeting system; and
processing circuitry configured to receive the attitude from the attitude determination unit, and programmed to at least:
determine a relative LOS from the targeting system to the field element based on the attitude and a geographic location of the targeting system, and a geographic location of the field element;
determine a relative position in the live view from the center of the field of view to the field element therein based on the relative LOS; and
cause the personal display system to display a primary view that overlays and thereby augments the live view, the primary view including an icon at the relative position that thereby overlays the field element in the live view.

2. The targeting system of claim 1, wherein the attitude determination unit is configured to persistently measure the attitude, and the processing circuitry is configured to persistently receive the attitude, and programmed to persistently determine the relative LOS based on the attitude, determine the relative position in the live view based on the relative LOS, and cause the personal display system to display the primary view including the icon at the relative position.

3. The targeting system of claim 1 further comprising a memory storing a classification of the field element, the classification being of a plurality of classifications associated with a respective plurality of icons,
wherein the processing circuitry is further configured to access the memory, and programmed to cause the personal display system to display the primary view including the icon associated with the classification of the field element.

4. The targeting system of claim 3, wherein the processing circuitry is programmed to cause the personal display system to display the primary view further including a notification regarding the field element in an instance in which the relative position and the center of the field of view are co-aligned, the notification being selected from a plurality of notifications based on the classification of the field element.

5. The targeting system of claim 3, wherein the field element is one of a plurality of field elements in the physical environment, and the memory stores a classification of each of the plurality of field elements,
wherein the processing circuitry is programmed to determine the relative LOS from the targeting system to each of the plurality of field elements, and
wherein the processing circuitry is further programmed to identify the field element as having a relative position within the field of view based on the relative LOS from the targeting system to the field element.

6. The targeting system of claim 5, wherein the processing circuitry is further programmed to identify another field element as having a relative position outside the field of view based on the relative LOS from the targeting system to the other field element, and
wherein the processing circuitry is programmed to cause the personal display system to display the primary view that further includes an arrow indicating a turning direction from the LOS of the targeting system to the other field element.

7. The targeting system of claim 1, wherein the processing circuitry is further programmed to cause the personal display system to display a secondary view that also overlays and thereby further augments the live view, the secondary view depicting an area of the environment surrounding the targeting system, and including icons that represent the targeting system and field element.

8. The targeting system of claim 7 further comprising a memory storing a classification that identifies the field element as a target, and information that indicates a munition assigned to the target, and a minimum safe distance associated with the munition, and
wherein the processing circuitry is further configured to access the memory, and programmed to cause the personal display system to display the secondary view including an indicator that indicates the minimum safe distance relative to the target.

9. The targeting system of claim 7, wherein the secondary view is centered on the icon that represents the targeting system,
wherein the processing circuitry is further programmed to determine a distance from the targeting system to the field element based on the geographic location of the targeting system and the geographic location of the field element, and
wherein the processing circuitry is programmed to cause the personal display system to display the secondary view centered on the icon that represents the targeting system, and in which the icon that represents the field element is positioned relative to the center of the secondary view based on the distance from the targeting system to the field element, and the relative LOS from the targeting system to the field element.

10. The targeting system of claim 1 further comprising a rangefinder configured to measure a range from the targeting system to a landmark in the physical environment, and
wherein the processing circuitry is further programmed to determine the geographic location of the targeting system based on the attitude of the targeting system, the range from the targeting system to the landmark, and a geographic location of the landmark.

11. A method of using a targeting system in a physical environment including a field element, the method comprising:
generating or enabling a live view of the physical environment, the live view including the field element and having a field of view centered on a line of sight (LOS) of the targeting system;
measuring an attitude of the targeting system in an azimuth and elevation that describe the LOS of the targeting system, and in a tilt of the targeting system;
determining a relative LOS from the targeting system to the field element based on the attitude and a geographic location of the targeting system, and a geographic location of the field element;
determining a relative position in the live view from the center of the field of view to the field element therein based on the relative LOS; and
displaying a primary view that overlays and thereby augments the live view, the primary view including an icon at the relative position that thereby overlays the field element in the live view.

12. The method of claim 11, wherein the measuring the attitude, determining the relative LOS, determining the relative position and displaying the primary view are performed persistently.

13. The method of claim 11, wherein the field element has a classification of a plurality of classifications associated with a respective plurality of icons, and
wherein displaying the primary view includes displaying the primary view including an icon associated with the classification of the field element.

14. The method of claim 13, wherein displaying the primary view includes displaying the primary view further including a notification regarding the field element in an instance in which the relative position and the center of the field of view are co-aligned, the notification being selected from a plurality of notifications based on the classification of the field element.

15. The method of claim 13, wherein the field element is one of a plurality of field elements in the physical environment, and each of the plurality of field elements have a classification,
wherein determining the relative LOS includes determining the relative LOS from the targeting system to each of the plurality of field elements, and
wherein the method further comprises identifying the field element as having a relative position within the field of view based on the relative LOS from the targeting system to the field element.

16. The method of claim 15 further comprising identifying another field element as having a relative position outside the field of view based on the relative LOS from the targeting system to the other field element, and
wherein displaying the primary view includes displaying the primary view that further includes an arrow indicating a turning direction from the LOS of the targeting system to the other field element.

17. The method of claim 11 further comprising displaying a secondary view that also overlays and thereby further augments the live view, the secondary view depicting an area of the environment surrounding the targeting system, and including icons that represent the targeting system and field element.

18. The method of claim 17, wherein the field element has a classification that identifies the field element as a target, a munition is assigned to the target, and the munition has a minimum safe distance associated therewith, and
wherein displaying the secondary view includes displaying the secondary view including an indicator that indicates the minimum safe distance relative to the target.

19. The method of claim 17, wherein the secondary view is centered on the icon that represents the targeting system,
wherein the method further comprises determining a distance from the targeting system to the field element based on the geographic location of the targeting system and the geographic location of the field element, and
wherein displaying the secondary view includes displaying the secondary view centered on the icon that represents the targeting system, and in which the icon that represents the field element is positioned relative to the center of the secondary view based on the distance from the targeting system to the field element, and the relative LOS from the targeting system to the field element.

20. The method of claim 11 further comprising:
measuring a range from the targeting system to a landmark in the physical environment; and
determining the geographic location of the targeting system based on the attitude of the targeting system, the range from the targeting system to the landmark, and a geographic location of the landmark.
